(19) United States
(12) Patent Application Publication
(10) Pub. No.: US 2004/0061607 A1
(43) Pub. Date: Apr. 1, 2004

(54) Signal device

(76) Inventor: Steve Pargman, San Francisco, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/256,773

(22) Filed: Sep. 27, 2002

(51) Int. Cl. G08B 1/08

(52) U.S. Cl. 340/539.15

(57) ABSTRACT

A signal device for generating audio and visual signals in response to a signal. The device includes a sensor which sends a signal generated near the sensor. The device further includes an announcer to receive the signal from the sensor. An indicator associated with the sensor visually displays information relating to signal while another indicator associated with the announcer visually displays information relating to the signal.

### BACKGROUND OF THE INVENTION

This invention relates to a signal device, and is particularly concerned with methods and apparatus for generating audio and visual signals in response to a signal. In particular, the invention relates to generating audio and visual signals in response to a baby.

Baby monitors are common household products used to notify caregivers of a baby or toddler's sleeping condition. The baby monitor typically includes a transmitter and a receiver, wherein the transmitter is positioned near the baby while the receiver is positioned at a different location. In use, the baby makes noise picked up by the transmitter, which transmits the noise to the receiver. Accordingly, the receiver broadcasts the noise to the caregiver usually located in another room. Typically, both the transmitter and the receiver are configured as radio or “walkie-talkie” devices which are operated by a power source such as an electrical outlet or a battery pack.

A problem with these types of baby monitors is that the typical monitor does not provide a visual indication of the baby. Instead, the monitors only broadcast noises such as crying. Most users, however, prefer a pleasant visual reminder of the baby. Thus, while working in other rooms separate from the baby, the user wants to see or be reminded of the baby. Some users have simply positioned the receiver next to a picture of the baby. Due to the constant need to move the receiver, however, the movement of an additional picture frame with the receiver becomes increasingly inconvenient.

Another problem with these types of baby monitors, however, is the configuration of the monitors. The typical radio configuration for the baby monitor does not match the ensemble or decor of the baby's room. Additionally, the typical configuration does not match or blend with the decor of other rooms in the house. Accordingly, users do not prefer the look of the typical baby monitor. Some users have simply left the monitor near the power source to keep the monitor out of the way; but the monitor remains in visual sight leading to an unpleasant decorative feel and dissatisfaction by the user. Other users try to hide the monitor which leads to poor reception by the receiver. Additionally, hiding the monitor results in the user having to position the monitor in a difficult position such as a high shelf.

A need, therefore, exists to present a visual indication such as a pleasant reminder of the baby while still transmitting and receiving the requisite signals relating to the baby.

The solution must also provide multiple or interchangeable visual indicators to present different pleasant reminders of the baby to the user. A need also exists to present an aesthetic baby monitor that will easily and conveniently match the decor of the home. The solution, however, must be capable of being positioned in multiple locations while still offering a pleasant match to the room. The solution must also provide the requisite transmitting and receiving functions in each location. Further, a need exists for a receiver to receive transmissions from more than one transmitter. The solution, however, must present a visual indicator on the receiver corresponding to the specific transmitter being activated.

Baby monitors presently available do not provide much flexibility to the user to solve the current needs. For example, baby monitors only broadcast and receive noises. These baby monitors do not solve the current need as the user only experiences the noise generated by the baby. Accordingly, the known monitors do not provide a visual indication and/or reminder of the baby to the user. Additionally, these monitors do not solve the current need as the monitors are limited to the radio and “walkie-talkie” configurations. Accordingly, the user cannot match the monitor with the existing decor of a room. Thus, the user must try to conceal the monitor. Additionally, baby monitors currently available do not provide a receiver which presents a visual indicator to differentiate from multiple transmitters.

Thus, the current need requires a monitor that is convenient to use, simple in construction and includes a visual indication of the baby. Additionally, the current need requires a monitor that can prominently be displayed to match an existing room.

### SUMMARY OF THE INVENTION

The present invention provides for generating audio and visual signals relating to a baby. To that end, the invention provides a device and method that conveniently presents a pleasant visual reminder of the baby while the caregiver is located in another room.

In an embodiment, the present invention comprises a sensor which is configured to receive and send a signal generated by a baby. An indicator which is associated with the sensor includes a member wherein the member, in turn, displays visual information relating to the signal. The invention further includes an announcer which is configured to receive the signal from the sensor and to generate a response based on the signal. Another indicator which is associated with the announcer, includes another member which displays visual information relating to the signal. In an embodiment, the member of the indicator and the other indicator is a picture frame wherein the visual information is a picture positioned within the indicator and the other indicator.

An advantage of the present invention is to provide a signal device which includes a visual indication of the baby.

Another advantage of the present invention is to provide a signal device which aesthetically matches with a room.

Described in the accompanying drawings and following text is a signal device that provides audio and visual signals relating to a baby wherein the configuration leads to satisfied placement of the signal device within a plurality of rooms. Thus, the present invention disclosed herein provides a monitor which overcomes many of the inadequacies of monitors known in the art.

### BRIEF DESCRIPTION OF THE DRAWINGS

FIG. 1 is a pictorial diagram of an embodiment of the present invention.

FIG. 2 is a front elevation view of a component according to the present invention.

FIG. 3 is a side elevation view of FIG. 2.

FIG. 4 is a sectional side elevation view according to the present invention.

FIG. 5 is a back view according to the present invention.

FIG. 6 is a front view of another embodiment according to the present invention.

FIG. 7 is a front view of another embodiment according to the present invention.

FIG. 8 is a front view of another embodiment according to the present invention.

FIG. 9 is a front view of another embodiment according to the present invention.

### DESCRIPTION OF THE PREFERRED EMBODIMENTS

As discussed above, the present invention provides structures and other accommodations to generate signals for a monitor such as a baby monitor. The present invention efficiently and pleasantly presents audio and visual signals relating to the baby to the user.

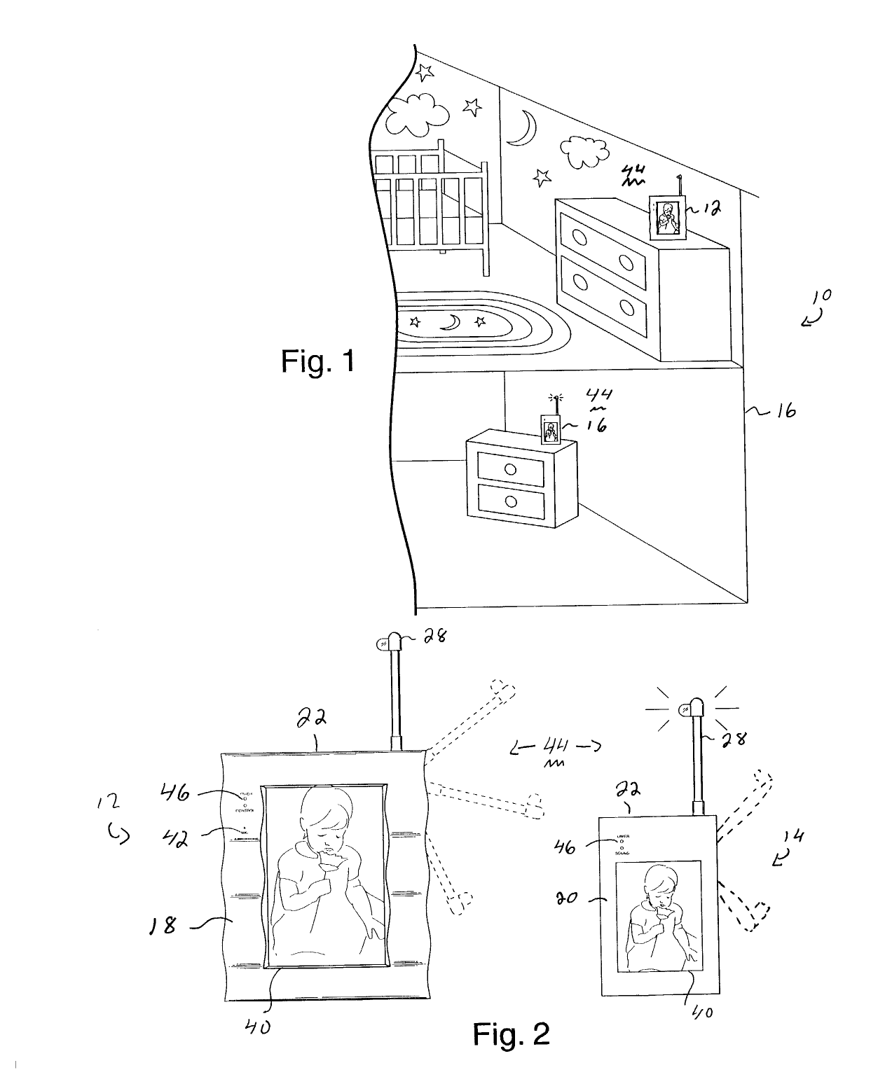

FIG. 1 diagrammatically illustrates an exemplary signal device 10 to present audio and visual signals. In FIG. 1 there is generally shown the signal device 10 as a baby monitor. As shown in FIG. 1, the signal device 10 comprises at least two components, a sensor 12 and an announcer 14. As shown, the sensor 12 and the announcer 14 are typically positioned in separate rooms in a house 16.

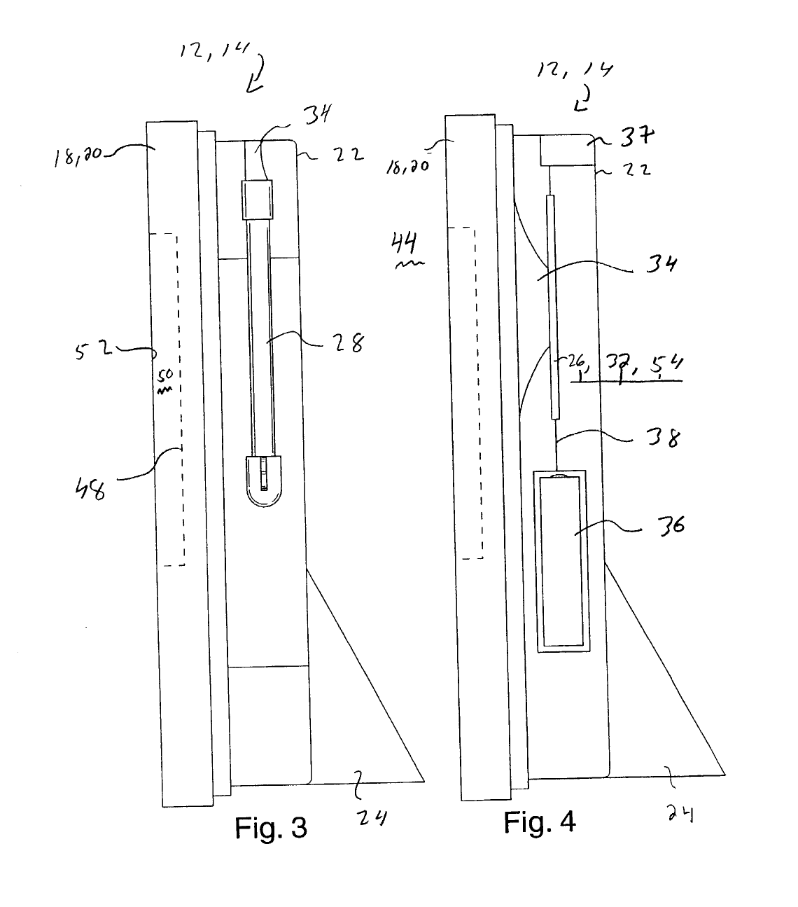

Turning to FIGS. 2-4, the sensor 12 and the announcer 14 are shown wherein an indicator 18 is associated with the sensor 12 and another indicator 20 is associated with the announcer 14. For clarity, the components of the sensor 12 are shown and described first. The sensor 12 includes a housing 22 and a base 24 (shown in FIG. 3) wherein the housing 22 encloses the electrical components 26 (shown in FIG. 4) while the base 24 supports the sensor 12.

The sensor 12 further includes an antenna 28 connected to the housing 22. The antenna 28 moves from a first position to a second position as shown in FIG. 2. In the first position, the antenna 28 is rotated to be near to the housing 22. In the second position, the antenna 28 is positioned upright with respect to the housing 22.

Turning to FIG. 3, the antenna 28 is shown in the first position wherein the indicator 18 hides the antenna 28. Thus, when viewed from the front, the antenna 28 cannot be seen by the user. Accordingly, during non-use, the antenna 28 is hidden by moving the antenna 28 to the first position to create a more appealing blend with the room decor. Thus, when the sensor 12 is placed on a room shelf during non-use, the unsightly antenna 28 is hidden to improve the aesthetics of the sensor 12. As shown, the antenna 28 moves by a rotator assembly 34. Other assemblies such as a hinge may also be used to move the antenna 28.

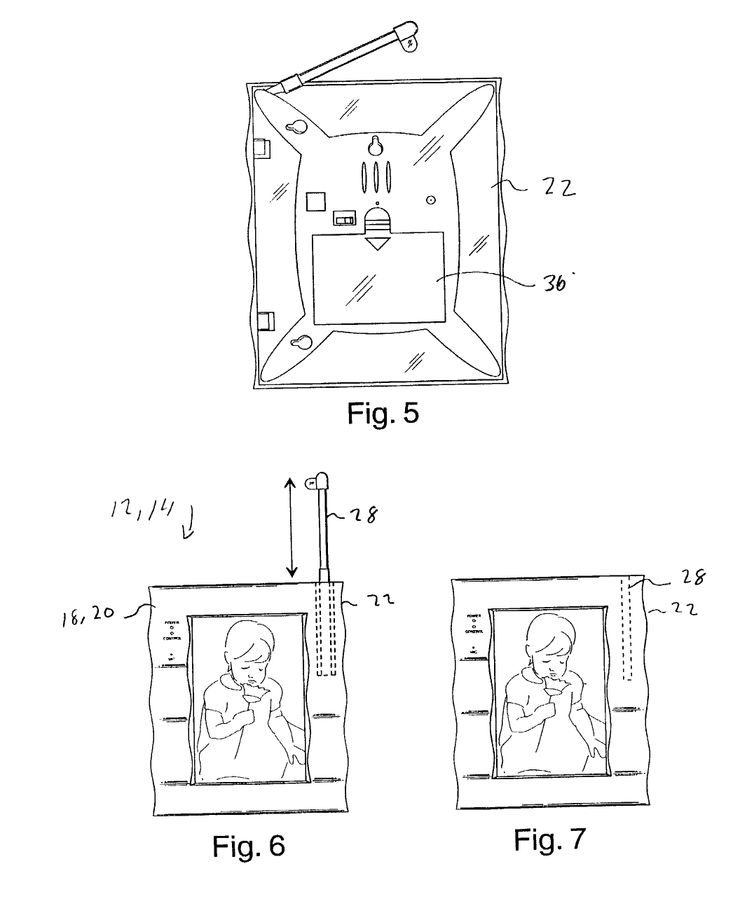

Turning to FIG. 4, the housing 22 encloses the components 26 including a transmitter 32 and a speaker 34. Additionally, a power source such as an electrical outlet (not shown) or a battery pack 36 powers the sensor 12. As shown, wires 38 connect the speaker 34, battery pack 36 and an antenna connection 37 to the transmitter 32. As shown in FIG. 5, the back of the housing 22 provides access to the battery pack 36.

Returning to FIGS. 2 and 3, the indicator 18 is associated with the sensor 12. Typically, the indicator 18 connects to the sensor 12 by a hinge such that the indicator 18 can swing open away from the sensor 12. The indicator 18 further includes a frame 40. As shown in FIG. 3, the indicator 18 hides the housing 22 when viewed from the front wherein the indicator 18 further provides an extension beyond the housing 22 to hide the antenna 28 in the first position. As shown in FIG. 2, the indicator 18 further includes a microphone 42. The microphone 42 receives signals 44 such as baby sounds, to transmit the signals 44 to the transmitter 32 as shown in FIGS. 3 and 4). Returning to FIG. 2, the indicator 18 includes a power signal 46 to indicate an activated sensor 12.

Referring to FIG. 3, the indicator 18 further includes a member 48 which displays visual information 50 relating to the baby to the user. The member 48, in turn, includes a cover 52 to protect the visual information 50. As shown in FIG. 2, the indicator 18 is a picture frame wherein the visual information 50, represented by a picture, inserts into the member 48. Accordingly, the cover 52 may include a glass plate to protect the visual information 50. Thus, with the antenna 28 hidden, the signal device 10 presents a pleasant picture frame to provide the visual information 50 representing the baby.

Referring to FIGS. 2 and 4, the announcer 14 is shown. The announcer 14 includes many of the same features of the sensor 12 such as the housing 22, base 24, antenna 28 and battery pack 36. Instead of a transmitter 32, however, the announcer 14 includes a receiver 54 (shown in FIG. 4) which receives the signal 44 transmitted by the sensor 12.

As shown in FIG. 2, another indicator 20 is associated with the announcer 14. Typically, the other indicator 20 is connected to the announcer 14 by a hinge such that the other indicator 20 can swing open away from the announcer 14. As in the sensor 12, the antenna 28 of the announcer 14 moves from a first position to a second position. In the first position, the antenna 28 positions near the housing 22 wherein in the second position, the antenna 28 positions upright with respect to the housing 22.

Accordingly, the other indicator 20 hides the antenna 28 while in the first position. Thus, when viewed from the front, the antenna 28 cannot be seen by the user in the first position. Accordingly, during non-use, the antenna 28 is hidden by moving the antenna 28 to the first position to create a more appealing match with the room decor.

As shown in FIG. 3, the other indicator 20 is larger than the housing 22 of the announcer 14. Accordingly, the other indicator 20 hides the housing 22 when viewed from the front. Thus, the other indicator 20 further provides an extension beyond the housing 22 to hide the antenna 28 in the first position. Similar to the sensor 12, the other indicator 20 includes the frame 40. The other indicator 20 further includes the speaker 34 (shown in FIG. 4) which transmits the signal 44 (shown in FIG. 2) received from the sensor 12 to the user. Additionally, as shown in FIG. 2, the other indicator 20 includes the power signal 46 which indicates an activated announcer 14.

Turning to FIG. 3, the other indicator 20 further includes the member 48 which displays visual information 50 relating to the baby to the user. The member 48, in turn, includes a cover 52 to protect the visual information 50. As shown, the other indicator 20 is a picture frame wherein the visual information 50 is represented by a picture inserted into the member 48. Accordingly, the cover 52 may include a glass plate to protect the visual information 50. Thus, with the hidden antenna 28, the signal device 10 presents a pleasant picture frame to provide the visual information 50 representing the baby.

Turning to FIG. 6, another embodiment is shown wherein aspects of the invention reside in an antenna 28 that extends and retracts with respect to the housing 22. Thus, instead of rotating, the antenna 28 retracts to the first position when the sensor 12 and announcer 14 are not activated. As shown, the indicator 18 and the other indicator 20 hide the antenna 28 when retracted to the first position in order to present a more pleasant blend with the room decor.

Turning to FIG. 7, another embodiment is shown wherein aspects of the invention reside in the antenna 28 that is formed part of the housing 22. Thus, instead of extending beyond the housing 22, the antenna 28 is formed within the housing 22. Accordingly, the housing 22 hides or camouflages the antenna 28 to present a more pleasant match with the room decor.

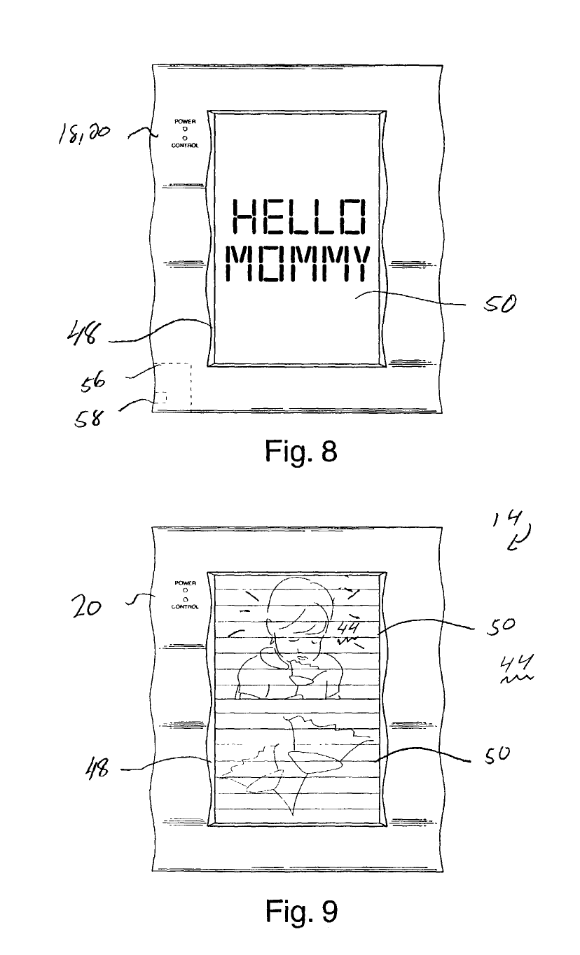

Turning to FIG. 8, another embodiment is shown wherein aspects of the invention reside in each member 48 of the indicator 18 and the other indicator 20 displays electronic information as the visual information 50. For this embodiment, the member 48 includes a screen such as an LED screen. Thus, electronic information such as text messaging is downloaded into a chip 56 via a link 58. Further, digital photos may be loaded into the chip 56. Accordingly, in this embodiment, the visual information 50 displayed by the member 48, such as the text messaging or digital photos, is interchangeable to present different visual information 50 to the user. Thus, in this embodiment, the member 48 of the sensor 12 and announcer 14 presents changing visual reminders of the baby to the user.

Still further, in another embodiment shown in FIG. 9, aspects of the invention reside in the announcer 14 receiving signals 44 from more than one sensor 12 (not shown). Thus, sensors 12 placed in different locations transmit signals 44 from each location to the announcer 14. The announcer 14, in turn, creates a response signal 44 to indicate which sensor 12 transmitted the signal 44. In one embodiment, the member 48 of the other indicator 20 includes visual information 50 for each sensor 12 wherein the announcer 14 generates a response signal 44 identifying the sensor 12. For example, the member 48 includes the visual information 50 represented by multiple pictures corresponding to the multiple sensors 12 wherein the other indicator 20 may light and/or highlight the picture corresponding to the activated sensor 12. Accordingly, the member 48 displays electronic information such as text messaging or digital photos to indicate the activated sensor 12.

Turning to FIGS. 1-9, the present invention provides a unique method of presenting signals 44. As shown in FIGS. 1 and 2, the signal 44, such as noise typically generated by the baby is received by the sensor 12. Accordingly, the signal 44 is a sensory signal such as an audio noise. The signal 44, however, may also include a visual signal such as movement by the baby. The signal, in audio form, is picked up by the microphone 42 of the indicator 18. In another embodiment, the signal 44, in visual form, is picked up by another device such as an electrical eye (not shown) or camera as known in the art.

During non-use, the antenna 28 moves to the first position behind the indicator 18. Thus, the antenna 28, hidden by the sensor 12 in the first position, presents a more pleasant blend with the room decor. During use, the antenna 28 moves from the first position to the second position while the sensor 12 is activated to receive the signal 44, i.e., the baby noise. The transmitter 32 then processes the signal 44 and transmits it to the announcer 14 for further processing.

Next, the signal 44 sent by the sensor 12 is received by the announcer 14. The announcer 14, in turn, generates the response signal 44. In the embodiment shown, the response signal 44 is in audio form broadcasted through the speaker 34. In another embodiment, the response signal 44 is in visual form such as a light.

Prior to or after placing the sensor 12 in a preferred location, the user places visual information 50 relating to the signal 44 in the indicator 18. In one embodiment, the user opens the indicator 18 and positions the visual information 50 within the member 48. Thus, in an embodiment, the indicator 18 presents visual information 50 relating to the signal 44 such as a picture of the baby. Accordingly, the indicator 18 pleasantly reminds the user of the signal 44 in visual form.

Similar to the sensor 12, the user places the announcer 14 in a preferred location while positioning the visual information 50 within the member 48 of the other indicator 20. In an embodiment, the visual information 50 is a picture positioned within the member 48. Accordingly, the user is pleasantly reminded of the signal 44 visually by the other indicator 20 and the visual information 50.

In another method of use, shown in FIG. 6, the antenna 28 retracts to the first position and extends to the second position for both the sensor 12 and announcer 14. Thus, during this use, the indicator 18 and the other indicator 20 hide the antenna 28 when the antenna 28 moves to the first position. Accordingly, in this method, the antenna 28 is hidden during non-use to present a more pleasant blend with the room decor.

In another method of use, as shown in FIG. 7, the antenna 28 is formed within the sensor 12 and announcer 14. Thus, during this use, the sensor 12 and announcer 14 hide or camouflage the antenna 28. Accordingly, in this method, the antenna 28 is hidden to present a more pleasant blend with the room decor.

In another method of use, as shown in FIG. 8, the user downloads or “syncs” electronic information such as text messaging or digital photos into the sensor 12 and the announcer 14. Accordingly, the indicator 18 and the other indicator 20 display the loaded information as the visual information 50. This method further changes the visual information 50 based on information programmed into the sensor 12 and/or the announcer 14.

Further, in another method of use shown in FIG. 9, multiple sensors 12 send signals 44 to the same announcer 14. Thus, for example, when a caregiver is watching two babies, two sensors 12 may be utilized. The announcer 14, meanwhile, indicates to the user which sensor 12 is activated. For example, the announcer 14 may include two pictures as the visual information 50 wherein the announcer 14 will light up the appropriate picture. The announcer 14 may also project different audio response signals 44 based on the activated sensor 12.

As is apparent from the foregoing specification, the invention is susceptible of being embodied with various alterations and modifications which may differ particularly from those that have been described in the preceding specification and description. It should be understood that we wish to embody within the scope of the patent warranted hereon all such modifications as reasonably and properly come within the scope of our contribution to the art.

1. A signal device, comprising:
a sensor, the sensor configured to send a signal generated near the sensor;
an indicator associated with the sensor, the indicator having a member which displays information relating to the signal;
an announcer, the announcer configured to receive the signal sent by the sensor, the announcer further configured to generate a response based on the received signal; and
another indicator, the other indicator associated with the announcer wherein the other indicator has another member to display information relating to the signal.

2. The signal device of claim 1, wherein the sensor further comprises a receiver to receive the signal.

3. The signal device of claim 1, wherein the sensor is a transmitter.

4. The signal device of claim 1, wherein the signal is a sensory signal.

5. The signal device of claim 4, wherein the sensory signal is an audio signal.

6. The signal device of claim 4, wherein the sensory signal is a visual signal.

7. The signal device of claim 1, wherein the member displays visual information.

8. The signal device of claim 7, wherein the visual information is a picture.

9. The signal device of claim 7, wherein the member is a picture frame.

10. The signal device of claim 1, wherein the announcer is receiver.

11. The signal device of claim 1, wherein the other member displays visual information.

12. The signal device of claim 11, wherein the visual information is a picture.

13. The signal device of claim 11, wherein the other member is a picture frame.

14. The signal device of claim 1, wherein the sensor and the announcer communicate via a wireless link.

15. The signal device of claim 1, wherein the response is audio.

16. The signal device of claim 1, wherein the response is visual.

17. The signal device of claim 1, wherein the sensor and announcer each have an antenna.

18. The signal device of claim 17, wherein each antenna is rotatably connected to the sensor and the announcer.

19. The signal device of claim 17, wherein each antenna is extendably connected to the sensor and the announcer.

20. The signal device of claim 17, wherein each antenna is formed within the sensor and the announcer.

21. The signal device of claim 1, wherein the member and the other member are electrical displays.

22. An audio and visual signal device which sends and receives audio signals while displaying visual information identifying the audio signals, comprising:
a sensor, the sensor configured to receive and send audio signals generated near the sensor, the sensor having an antenna hidden by the sensor;
an indicator connected to the sensor, the indicator having a member which displays visual information identifying the audio signal;
an announcer, the announcer configured to send and receive the audio signals sent by the sensor, the announcer further configured to generate an audio response based on the received audio signals, the announcer having another antenna hidden by the announcer; and
another indicator, the other indicator connected to the announcer wherein the other indicator has another member to display visual information identifying the audio signal.

23. The signal device of claim 22, wherein the visual information is a picture.

24. The signal device of claim 22, wherein the member and the other member are picture frames.

25. The signal device of claim 22, wherein each antenna is rotatably connected to the sensor and the announcer.

26. The signal device of claim 22, wherein each antenna is extendably connected to the sensor and the announcer.

27. The signal device of claim 22, wherein each antenna is formed within the sensor and the announcer.

28. A method of signaling a sensory signal, comprising:
receiving a sensory signal;
presenting visual information relating to the sensory signal by an indicator;
transmitting the sensory signal to generate a response; and
presenting visual information relating to the sensory signal by another indicator.

29. The method of signaling according to claim 28, wherein the sensory signal is an audio signal.

30. The method of signaling according to claim 28, further comprising positioning the visual information within a member.

31. The method of signaling according to claim 28, wherein the visual information is a picture.

32. The method of signaling according to claim 28, wherein the indicator is a picture frame.
